(19) United States
(12) Patent Application Publication
(10) Pub. No.: US 2011/0221605 A1
(43) Pub. Date: Sep. 15, 2011

(54) MAT ACTIVATED INDICATOR

(76) Inventors: Susan H. Niemann, Northbrook, IL (US); Nicholas M. Nanos, Morton Grove, IL (US); Effie Nanos, Morton Grove, IL (US)

(21) Appl. No.: 12/723,360

(22) Filed: Mar. 12, 2010

(51) Int. Cl. G08B 21/00

(52) U.S. Cl. 340/666

(57) ABSTRACT

A mat activated indicator is disclosed. The indicator includes a mat to be placed either inside or outside a door. The mat can be activated by an increase in weight such as by a pet stepping on the mat. The mat includes a lower and upper plate which are held apart by a spacer such as a memory foam spacer. An increase in weight upon the mat causes the plates to make contact and close a switch circuit. A transmitter sends a wireless signal upon activation of the switch. The signal is received by a receiving unit. The receiving unit provides an audible, visual, or vibrating signal to provide notice to a pet owner that a pet is stepping on the mat and may want to enter or exit through the door. In various optional variations, the receiving unit produces a signal of musical tones, and may have a choice of musical tones.

### BACKGROUND OF THE INVENTION

1. Field of the Invention

The present invention relates to a mat activated indicator, and more particularly, to a mat which includes a switch, a transmitter, and a receiver.

2. Background

Various alert systems for pets have been proposed which allow an animal to signal an owner. For example, U.S. Pat. No. 6,445,302 issued to Vena discloses a pet doorbell device which has a mounted sensor for a pet to paw at to send an alert to an owner. However, it may be difficult to train a pet to paw at the device, and thus may not be reliable in its effectiveness for different situations.

U.S. Pat. No. 5,475,369 issued to Baker discloses a vertically mounted device for a pet to paw at to send a signal such as to a doorbell type device. Again, it may be difficult to train certain pets to use the device properly. Thus, it may not be reliable in various situations.

In other disclosures, further forms of indicators are disclosed. For example, U.S. Pat. No. 4,924,214 issued to Hill discloses a mat sensor which has multiple switches in various locations in the mat. Such an embodiment requires many components so that multiple switches can activate depending on where an animal might step.

In U.S. Pat. No. 7,057,515 issued to Smith et al., a sensor is disclosed. However, it is not low profile like a mat and would be inconvenient to place near a doorway.

U.S. Pat. No. 4,551,713 issued to Aossey discloses a pet alarm system using a mat. However, the system requires hard wiring to a signaling device. This is very inconvenient because unsightly wires would be in the way, and the installation of such a device is difficult. Furthermore, the location of the signaling device would be permanent.

The pet operable annunciator disclosed in U.S. Pat. No. 4,686,504 issued to German discloses a mountable device for a pet to paw at. It requires a permanent installation and again requires particular training of a pet which may not be possible in many situations.

U.S. Pat. No. 5,604,478 issued to Grady et al. also discloses a pet operable door chime. It is not low profile, and is very limited in how the person might be alerted of the signal.

Thus, there remains a need for a low profile device which does not require special installation, pet training, or unsightly obstacles, and which provides various convenient options to alert an owner of a pet activating the device.

### SUMMARY

The present invention is a mat activated indicator. The indicator enables an animal, for example, to indicate to a person inside a house or other building, that the animal has stepped on the mat. A pet may step on such a mat when it is trying to enter or exit through a door. A sensing unit includes the mat, and will send a signal to a receiver unit which will alert the owner.

The mat may be included in a housing or base placed near the door. In certain embodiments, the mat includes a switch which is activated by pressure being applied to the mat. For example, the mat may include two parallel conductive plates spaced apart by a spacer. When a certain amount of pressure is applied to the mat, the plates are pushed together and make contact to close the switch circuit.

The spacer is optionally a memory foam which holds the plates apart, is compressed when pressure is applied, and then returns to its original configuration when the pressure is removed in order to separate the plates again.

In certain preferred embodiments, the housing of the device holds the mat in one location, and adjacent the mat the other required electronics are housed. For example, a power source such as a battery or set of batteries are housed in a separate compartment, and a transmitter and any other required circuitry is housed separate from the mat. Ideally, these items are housed in a way which maintains a relatively low profile for that compartment.

The transmitter preferably sends a wireless signal when activated to a receiver unit which would usually be inside the house or building. The receiver unit receives the signal and alerts a nearby person of the incoming signal. It provides an indicating notice which can be in any of various forms. For example, it may be auditory, it may be visual, or it may be tactile such as a vibrating alert. Since the sensing unit can be placed on the inside side or the outside side of a door, it may be used to alert a person that a pet wishes to either exit or enter a building or house.

In certain embodiments in which the alert is auditory, it may include musical tones. Optionally, the receiver unit may have settings which enable a user to choose between two or more alerts which might be different musical tones or tunes. In other embodiments, the alert may be a flashing light or other visual signal.

In various embodiments, the receiver unit may be portable so that it can be moved around a house or building. A receiver unit may even include a belt clip and be portable so that a user can keep the unit at hand at any time. A vibrating alert may be provided on a portable unit which will enable a person to sense the alert by feeling the vibration of the device while it is worn.

In other embodiments, multiple sensing units may be provided. For example, sensing mats could be placed at different doorways. Each sensing unit might send a signal to the same receiver unit, or to different receiver units. Optionally, a single receiving unit may have different alerts corresponding to signals received from different mats so that the user know which mat is activated, and thus, which door to open. In other embodiments, a single sensing unit may have a signal which is received by multiple receiver units placed in different locations.

Still other objects and advantages of the present invention will become readily apparent to those skilled in the art from the following detailed description, wherein it is shown and described only the preferred embodiments of the invention, simply by way of illustration of the best mode contemplated of carrying out the invention. As will be realized, the invention is capable of other and different embodiments and its several details are capable of modifications in various obvious respects, without departing from the invention. Accordingly, the drawings, wherein like reference numerals represent like features, and description are to be regarded as illustrative in nature and not as restrictive.

### BRIEF DESCRIPTION OF THE DRAWINGS

FIG. 1 shows a perspective view of one embodiment of the indicator of the present invention.

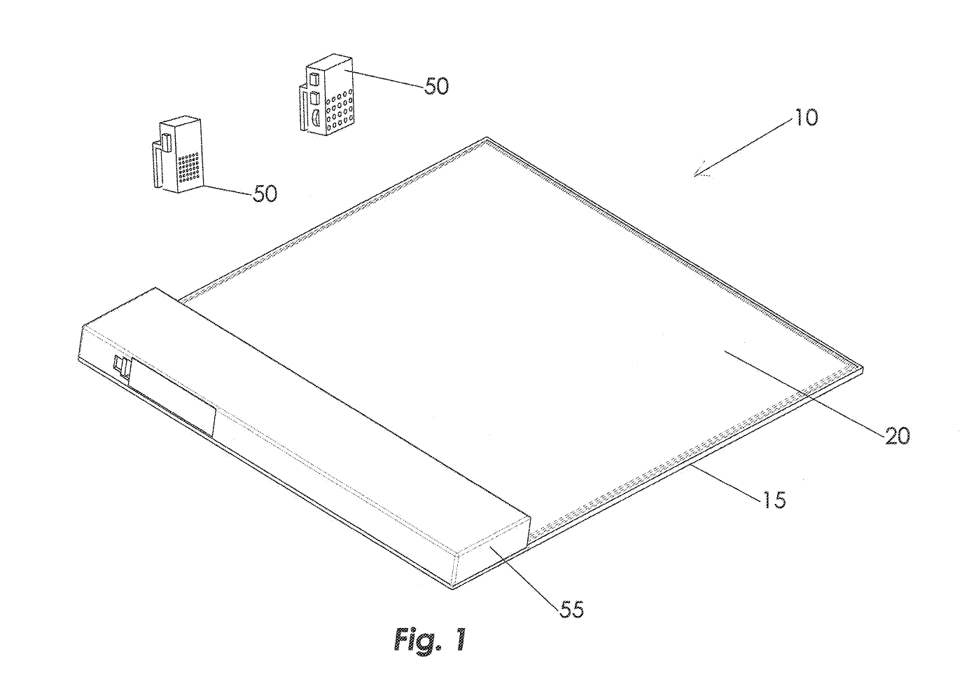

FIG. 2 shows a perspective view of one embodiment of the mat of the present invention.

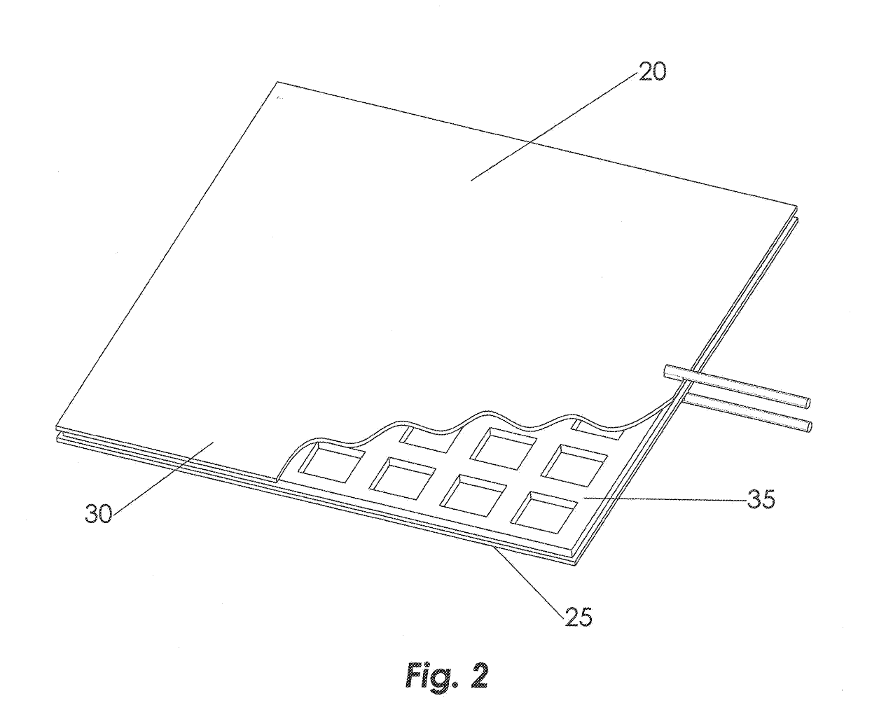

FIG. 3 shows a perspective view of one embodiment of the housing, power source, and transmitter of the present invention.

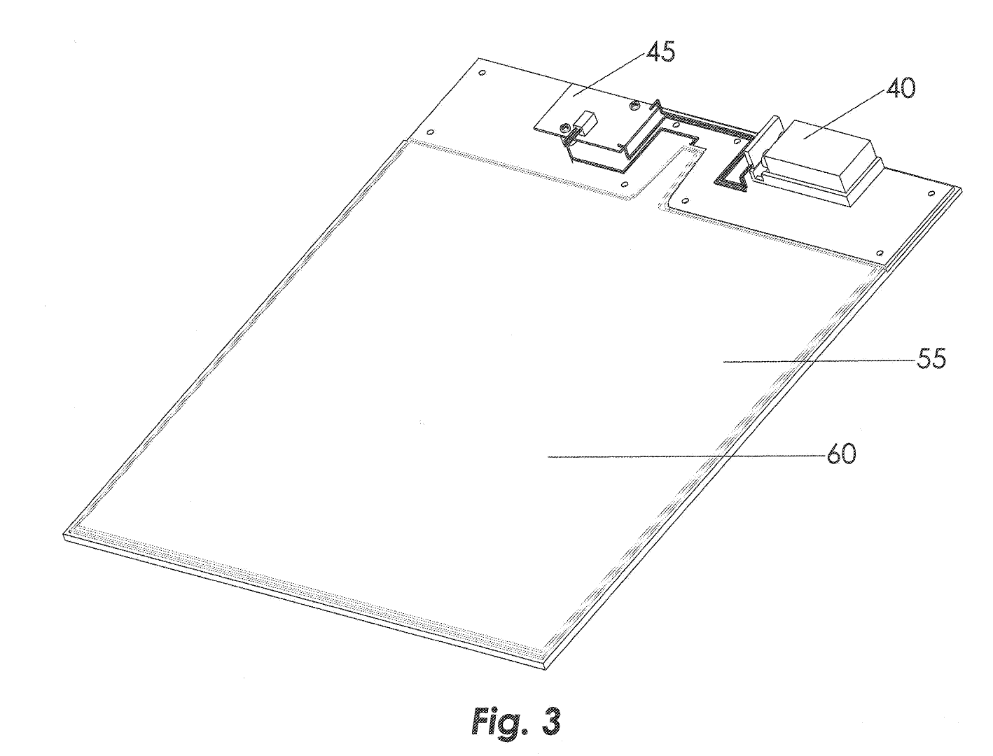

FIG. 4 shows a perspective view of one embodiment of a portion of the housing of the present invention which covers the power source and transmitter.

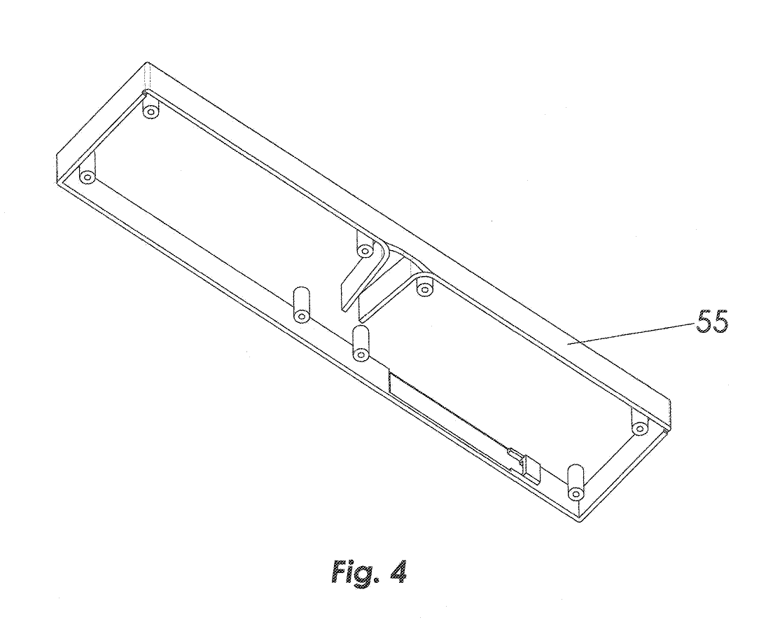

### DETAILED DESCRIPTION OF THE INVENTION

While this invention is susceptible of embodiments in many different forms, there are shown in the drawings and will herein be described in detail, preferred embodiments of the invention with the understanding that the present disclosure is to be considered as an exemplification of the principles of the invention and is not intended to limit the broad aspect of the invention to the embodiments illustrated.

The present invention is a mat activated indicator 10. The mat indicator 10 includes a sensing unit 15. The sensing unit 15 is adapted to sense an increase in weight of at least a minimum sensing amount upon the sensing unit 15. One purpose of the present invention is to enable a house pet to activate the sensing unit 15 to alert a pet owner that the pet may be ready to enter or exit through a door. Thus, the minimum sensing amount should be set such that a house pet will meet such a minimum. For small pets, this amount may be rather low, such as below five pounds. However, any suitable threshold of weight may be utilized.

The sensing unit 15 is activated by a switch. One such switch may include a mat 20. The mat 20 includes two substantially parallel plates: a lower conductive plate 25 and an upper conductive plate 30. These lower and upper plates 25 and 30 are separated by a spacer 35 such as a memory foam. In various embodiments, the memory foam holds the plates 25 and 30 apart, yet can be compressed when a weight is applied to allow the plates to make contact. The memory foam then returns to its configuration before being compressed. When the plates 25 and 30 make contact, the switch circuit is closed and the switch is activated.

The switch is operatively connected to a power source 40 and a transmitter 45. The power source 40 is optionally a single battery or a set of batteries. The batteries are accessible to enable replacement. When the switch is activated, the transmitter 45 sends a wireless signal which is received by a receiver unit 50.

When the receiver unit 50 receives a signal from the transmitter 45, it produces an indicating notice which can be sensed by a human. The indicating notice is any form of alert which can be sensed by a person. For example, it may be audible, visual such as a flashing light or other visual alert, or tactile such as a vibrating alert. It also may be any combination of these types of alerts.

In various embodiments, the present invention can be used to assist individuals who have difficulty sensing certain types of alerts. For example, an individual with a hearing loss or impairment can make use of a visual or vibrating signal. An individual who is visually limited may make use of an alert which is either auditory or vibrating.

In certain embodiments, the spacer 35, such as a memory foam, is optionally configured in a grid or matrix pattern. Thus, a grid of spaces in the pattern leave room for the plates 25 and 30 to make contact when activated. It is noted that any suitable configuration for the spacer 35 is also contemplated as within the scope of the present invention.

In various embodiments, sensing unit 15 includes a housing 55. The housing 55 is adapted to house the mat 20, as well as the power source 40 and transmitter 45. The housing 55 may be a rigid plastic, or any other suitable material. The housing 55 optionally includes a mat compartment 60 where the mat 20 is disposed. This may be open on a top side and the mat 20 may sit in it. The mat compartment 60 is optionally substantially rectangular in shape to hold a substantially rectangular shaped mat 20.

In certain embodiments, the housing 55 also includes a compartment for housing the power source 40 and transmitter 45. The power source and transmitter compartment is enclosed. Ideally, the housing 55 is water-resistant or even waterproof and preferably break-resistant so that the sensing unit 15 can suitably endure outdoor environmental factors. In certain embodiments, the mat compartment is horizontally displaced from the other compartment. Thus, the compartment for the power source and transmitter, which may be individually contained in subcompartments, is next to the mat. Ideally, the top surface of the power source and transmitter compartment is not raised too much above the top level of the mat 20. Thus, a low profile is achieved. Preferably, less than an inch differential is achieved, and more preferably, less than half an inch differential is achieved. The mat 20 may rest on top of a base portion of the housing 55 to expose the mat 20 at its top surface. Thus, the mat 20 is ideally water-resistant or even waterproof itself. The mat 20 is electrically connected to the remainder of the circuitry.

In certain embodiments which employ an audible notice or alert in the receiver unit 50, the notice may include a set of musical tones such as a portion of a musical tune or song. Optionally, the receiver unit may have settings to allow a choice of audible notices, such as different musical tunes or sets of musical tones, or other audible notices. A volume control is optionally included in the receiver unit 50 as well.

In various other embodiments, the receiver unit 50 may provide a vibrating notice. This can be done using any suitable vibrating device such as are conventionally available and used in cell phones, pagers, and the like. In a preferred embodiment, the receiver unit 50 is a portable device. For example, it may be a device which is or is similar to a pager. The receiver unit 50 can then be worn on a belt such as by using a belt clip, or can be worn or carried by the user in any other suitable manner such as in a pocket, around a lanyard, etc. Thus, a user who might have a hearing impairment can keep the receiver unit 50 on his or her person and be alerted by the vibrating notice.

In certain embodiments, the receiver unit 50 may have various optional features. For example, there may be an on and off button or switch in order to render the unit 50 active or inactive. It may be desirable for the receiver unit 50 to be inactive during certain periods of time. For example, at night it may be desirable that outdoor wild animals might step on the mat 20. The user may wish not to be bothered after certain hours. In certain preferred embodiments, a timer may be integrated into the receiver unit 50 to activate the unit 50 during certain specified hours, and deactivate it during others. Ideally, the user could set the time periods as desired.

In various embodiments, the present invention may include multiple sensing units 15 which might be placed inside or outside different doors, for example, or one inside and one outside of the same door. Optionally, these various units 15 might send signals to different receiver units 50, or to a single receiver unit 50 which optionally may have differentiation in the notice provided based on which sensing unit 15 sent the signal.

In other embodiments, multiple receiver units 50 may be provided to receive the signal from the same sensing unit 15. Thus, for example, one receiver unit 50 might be placed in one location in a house, and another unit 50 might be in another part of the house or might be a portable unit worn by the user. In this way, a user can be alerted by one or another of multiple receiver units 50 based on where the user is located or whether the user is carrying a portable receiver unit 50.

While specific embodiments have been illustrated and described, numerous modifications come to mind without significantly departing from the spirit of the invention and the scope of protection is limited by the scope of the accompanying claims.

What is claimed is:

1. A mat activated indicator comprising:
a sensing unit comprising a mat adapted to sense an increase in weight of at least a minimum sensing amount thereupon via activation of a switch,
a power source,
a receiver unit, and
a transmitter operatively connected to said power source and said switch and adapted to transmit a wireless signal to said receiver unit when said switch is activated, wherein said receiver unit produces an indicating notice which can be sensed by a human when said wireless signal is received by said receiver unit.

2. The mat activated indicator according to claim 1, wherein said mat comprises a lower conductive plate and an upper conductive plate having a spacer therebetween, and wherein such an increase in weight causes said lower conductive plate and said upper conductive plate to make contact and close a switch circuit.

3. The mat activated indicator according to claim 2, wherein said spacer comprises memory foam.

4. The mat activated indicator according to claim 3, wherein said memory foam is configured in a grid pattern between said lower plate and said upper plate.

5. The mat activated indicator according to claim 3, wherein said sensing unit comprises a housing adapted to house said at least a lower surface of said mat, said power source, and said transmitter.

6. The mat activated indicator according to claim 5, wherein said housing comprises a mat compartment configured to hold said mat, wherein said mat is substantially rectangular in shape, and wherein said housing further comprises a compartment for housing said transmitter and said power source in a position horizontally displaced from said mat.

7. The mat activated indicator according to claim 2, wherein said minimum sensing amount is less than five pounds.

8. The mat activated indicator according to claim 2, wherein said sensing unit is substantially water-resistant.

9. The mat activated indicator according to claim 2, wherein said indicating notice is an audible notice.

10. The mat activated indicator according to claim 9, wherein said audible notice comprises a set of musical tones.

11. The mat activated indicator according to claim 9, wherein said receiving unit comprises at least two selectable modes, and wherein each of said modes comprises a different set of musical tones.

12. The mat activated indicator according to claim 2, wherein said indicating notice is a visually detectable notice.

13. The mat activated indicator according to claim 12, wherein said visually detectable notice is a flashing light.

14. The mat activated indicator according to claim 2, wherein said indicating notice is a vibrating notice.

15. The mat activated indicator according to claim 14, wherein said receiving unit is portable.

16. The mat activated indicator according to claim 15, wherein said receiving unit further comprises a belt clip.

17. The mat activated indicator according to claim 2, wherein said receiving unit comprises a timer system configured to enable said receiving unit to be active during a specified portion of a day, and inactive during a different specified portion of a day.

18. The mat activated indicator according to claim 2, further comprising a second sensing unit.

19. The mat activated indicator according to claim 2, further comprising a second receiving unit.

20. The mat activated indicator according to claim 6, wherein a top surface of a portion of said housing covering said transmitter is not substantially vertically raised from a top surface of said mat.
